(19) United States
(12) Patent Application Publication
(10) Pub. No.: US 2007/0053353 A1
(43) Pub. Date: Mar. 8, 2007

(54) Method for processing subscriber packet using subscriber identification tag

(76) Inventors: Hyoung Il Lee, Daejeon (KR); Dae Geun Park, Daejeon (KR); Jeong Hee Lee, Daejeon (KR); Bhum Cheol Lee, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/321,191

(22) Filed: Dec. 29, 2005

(30) Foreign Application Priority Data
Sep. 7, 2005 (KR) 10-2005-0083120

(51) Int. Cl. H04L 12/56; H04L 12/66

(52) U.S. Cl. 370/389; 370/463

(57) ABSTRACT

A method of classifying packets by a subscriber and processing classified packet to provide fairness to subscribers is provided. In order to classify the packets by the subscriber, a subscriber identification tag is inserted into a predetermined portion of an Ethernet frame and the packets are classified using the subscriber identification tag. The classified packets are processed based on the classifying result. Accordingly, an intermediate node not directly connected to the subscriber can classify the packets by the subscriber even in an uncontrollably expanded subscriber network. Therefore, the subscriber network is simply and effectively managed while providing the fairness to the subscriber in processing packets and allocating bandwidth.

### RELATED APPLICATION

The present application is based on, and claims priority from, Korean Application Number 2005-0083120, filed Sep. 7, 2005, the disclosure of which is hereby incorporated by reference herein in its entirety.

### BACKGROUND OF THE INVENTION

1. Field of the Invention

The present invention relates to a method for identifying a subscriber using a subscriber identification tag, and more particularly, to a method for identifying a subscriber by inserting a subscriber identification tag in an Ethernet frame header so that an intermediate node classifies Ethernet frames by a subscriber in an Ethernet based subscriber network although the intermediate node is not directly connected to the subscriber and the subscriber network of typical topology includes a plurality of switching devices.

2. Description of the Related Art

One of major objects of a subscriber network is fair concentration of lines from a plurality of subscribers to one or a plurality of uplinks. In order to achieve such an object, it is ideal to use a single subscriber device 100 for concentrating subscriber lines in the subscriber network as shown in FIG. 1. The use of the single subscriber device 100 allows simple management of all subscriber ports under same conditions and effective control of subscriber lines reflecting real-time traffic variation in the subscriber network. However, to build the subscriber network with a single line concentrator requires a high capacity line concentrator and is not affordable in aspects of cost and scalability.

As shown in FIG. 2, subscriber networks generally have a tree structure configured of a plurality of connected Ethernet switches having 8 to 24 ports. In such a structure, intermediate nodes, which are not directly connected to a subscriber port, cannot classify received packets by a subscriber. As one of methods used in a conventional Ethernet switch, the received packets are classified by a MAC/IP address. It is not equivalent to the classifying of packets by a subscriber. It is because a subscriber is allowed to have several MAC or IP addresses in the Ethernet based subscriber network. After introducing Internet protocol version 6 (IPv6) into the Ethernet based subscriber network, digital appliances in home are allowed to have own IP addresses and a subscriber is also allowed to access the network through the several IP addresses of the digital appliance. Under such a network environment, the subscriber cannot be classified by the MAC or IP address. In case of providing services in a unit of IP or MAC address after classifying the subscribers by the IP or MAC addresses, a subscriber may use several IP/MAC addresses to virtually expand a his subscribing band. It is not easy to prevent the use of several IP/MAC addresses as a means of expanding the subscribing band.

To classify packets by a subscriber are very important in a subscriber network for guaranteeing the QoS. It is because: 1) a corresponding QoS must be guaranteed to a subscriber since a cost of service is charged by a subscriber; 2) it requires a high cost to adapt a method of classifying packets by a flow into the subscriber network, where the method is recently employed in a core network; and 3) it is required to solve a cousin fairness problem caused by unfair allocation of bandwidth to a subscriber. The cousin fairness problem is arisen because the allocated bandwidth is varied according to a location of a subscriber port accessing the uplink in an expanded subscriber network having a typical topology.

As described above, the core network recently adapts the method of classifying packets by a flow for guaranteeing the QoS. Such a conventional classification method classifies received packets in a session unit by five classification standards that are an IP origin address, an IP destination address, a TCP/UDP protocol a TCP/UDP origin port and a TCP/UDP destination protocol. Herein, the session unit is a basic unit of Internet communication. Then, the received packets are processed in the session unit based on the five classifications. The conventional classification method guarantees the QOS of packet communication according to characteristics of each communication session. For example, the VoIP session is very sensitive to delay. However, numerous sessions must be managed and the received packets must be classified in real time according to the conventional classification method. Accordingly, it requires mass storage and high processing power. Also, it is very difficult to implement. Due to such drawbacks, adaptation of the conventional classification method is hesitated even for the core network. Also, it is not suitable to employ the conventional classification method in the subscriber network in aspects of cost and implementation difficulties.

Because the Internet service cost is charged in a unit of a subscriber, fair QoS must be provided to each subscriber.

It is very important to provide fair QoS to each of subscribers because the cost of using the Internet service is charged in a unit of the subscriber. Although the received packets are classified by the flow to guarantee the QoS, it is impossible to identify a subscriber of the flow. Therefore, the conventional classification method may fairly provide the QoS according to the traffic flow but the fair QoS cannot be provided according to a subscriber. For example, if a subscriber occupies a plurality of traffic flows while the QoS is guaranteed according to the traffic flow, the subscriber having more traffic flows will have more services than other subscriber having less traffic flows.

In the general subscriber network having a typical topology as shown in FIG. 2, the cousin fairness problem is arisen among subscribers according to an accessing location of a subscriber. As shown in FIG. 2, a subscriber 1 accesses the uplink through less subscriber devices than a subscriber 8. That is, the subscriber 1 may accesses the uplink with less traffic collisions. It is equivalent that the subscriber 1 occupies comparative wider bandwidth that the subscriber 8 and the subscriber 1, therefore, may have better QoS than the subscriber 8. As describer above, fairness between subscribers is not provided in the general subscriber network shown in FIG. 2. Such an unfairness problem is generally called the cousin fairness problem. The cousin fairness problem is not solved through classifying the packets either by the MAC/IP address or by the flow. The packets must be classified by a subscriber to solve the cousin fairness problem. That is, it is impossible to provide a fair line concentration in the expanded subscriber network having a typical topology because conventional subscriber network devices do not classify or process the packets by a subscriber.

A conventional method of guaranteeing the QoS of each connection in a data communication network is introduced in U.S. Pat. No. 6,449,650 B1, entitled “Method and apparatus for deploying quality of service policies on a data communication network”, issued at Sep. 10, 2002. However, the conventional method requires that a network policy management system (NPMS) must define types of services and a subscriber must input a type of a target service into a subscriber device.

Also, another conventional classification method is disclosed in U.S. Pat. No. 6,795,441 B1, entitled “Hierarchy tree-based quality of service classification for packet processing” issued at Sep. 21, 2004. In another conventional method, a hierarchy tree based packet classification method is used to process packets arrived at a network device according to QoS of each packet. However, the hierarchy tree based packet classification method classifies packets by only subscribers directly connected to a network device.

Therefore, there is great demand for an effective packet processing method that classifies and processes packets by a subscriber in an intermediate node which is not directly connected to a subscriber in order to guarantee fairness to subscribers in an expanded subscriber network having a typical topology.

### SUMMARY OF THE INVENTION

Accordingly, the present invention is directed to a method of processing subscriber packets using subscriber identification tag that substantially obviates one or more problems due to limitations and disadvantages of the related art.

An object of the present invention is to provide a method of identifying a subscriber using a subscriber identification tag for fairly distributing bandwidth to subscribers without regard to a location of a port connected to a subscriber in an extended subscriber network having a typical topology by inserting a subscriber identification tag in a header of an Ethernet frame at each of switches in the subscriber network, classifying the packets by a subscriber based on the identification tag and processing the packets according to the classifying result.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of processing a packet using a subscriber identification tag in an Ethernet network includes the steps of: receiving an Ethernet frame from a subscriber at an edge node directly connected to the subscriber in the Ethernet network and forming a subscriber identification tag by inserting a subscriber ID (identification) for identifying the subscriber in a predetermined portion of an Ethernet frame header in the received Ethernet frame; classifying a Ethernet frame according to its subscriber by reading a subscriber identification tag included in an Ethernet frame header in the Ethernet frame at an intermediate node in the Ethernet network; and processing the classified Ethernet frame according to each of subscribers.

In the step of forming the subscriber identification tag, the subscriber ID may be recorded in a field for recording VLAN (virtual local area network) ID in a VLAN tag of an Ethernet frame defined in IEEE 802.1Q and the VLAN tag may be used as the subscriber identification tag.

In the step of forming the subscriber identification tag, the subscriber ID may be recorded in a field for recording a VLAN tag in an Ethernet frame defined in IEEE 802.1Q and the VLAN tag may be used as the subscriber identification tag.

In the step of forming the subscriber identification tag, the subscriber ID is recorded in a field for recording an S-VLAN ID in an S-VLAN tag of an Ethernet frame defined in a Q-in-Q scheme and the S-VLAN tag may be used as the subscriber identification tag.

In the step of forming the subscriber identification tag, the subscriber ID may be recorded in a field for recording an S-VLAN tag in an Ethernet frame defined in a Q-in-Q scheme and the S-VLAN tag may be used as the subscriber identification tag.

In the step of forming the subscriber identification tag, the subscriber ID may be recorded in a field for recording a C-VLAN (conventional-VLAN) ID in a C-VLAN tag of an Ethernet frame defined in a Q-in-Q scheme and the C-VLAN tag may be used as the subscriber identification tag.

In the step of forming the subscriber identification tag, the subscriber ID may be recorded in a field for recording a C-VLAN tag in an Ethernet frame defined in a Q-in-Q scheme and the C-VLAN tag may be used as the subscriber identification tag.

In the step of forming the subscriber identification tag, a new Ethernet type value may be inserted in a predetermined portion of the received Ethernet frame and the subscriber identification tag having the subscriber ID may be formed at the next of the predetermined portion for the new Ethernet type value.

The subscriber identification tag may include a field representing a priority of a packet to be processed.

In the step of forming the subscriber identification tag, a MPLS (multi-protocol label switching) header may be inserted into the received Ethernet frame, the subscriber ID may be recorded in a field of recording a MPLS label in the MPLS header and the MPLS header is used as the subscriber identification tag.

In the step of classifying, the Ethernet frames may be classified according to the subscriber ID in the subscriber identification tag and a priority.

In the step of classifying, the priority may be recorded in the subscriber identification tag.

In the step of classifying, the Ethernet frames may be classified by the subscriber ID of the subscriber identification tag and a flow.

In the step of processing, the classified Ethernet frames may be processed to guarantee fairness to the subscriber.

The step of processing may include the steps of: determining whether a destination of the Ethernet frame is a different Ethernet device or subscriber device which is directly connected from the edge node; and removing the subscriber identification tag from the Ethernet frame if the destination of the Ethernet frame is the different Ethernet device or subscriber device which is directly connected from the edge node.

The step of processing may include the step of limiting a bandwidth of each subscriber based on the classified Ethernet frames according to the subscriber.

The step of processing may include the step of storing the classified Ethernet frames according to an order of classifying.

The step of processing may include the step of deciding an order for outputting the classified Ethernet frame as an order of classifying.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram of an ideal structure of a subscriber network expended as a typical topology according to the related art;

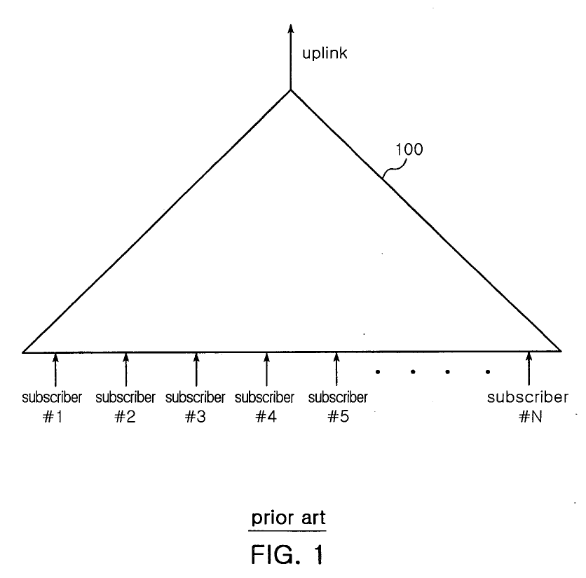

FIG. 2 is a diagram of a subscriber network expended as a typical topology according to the related art;

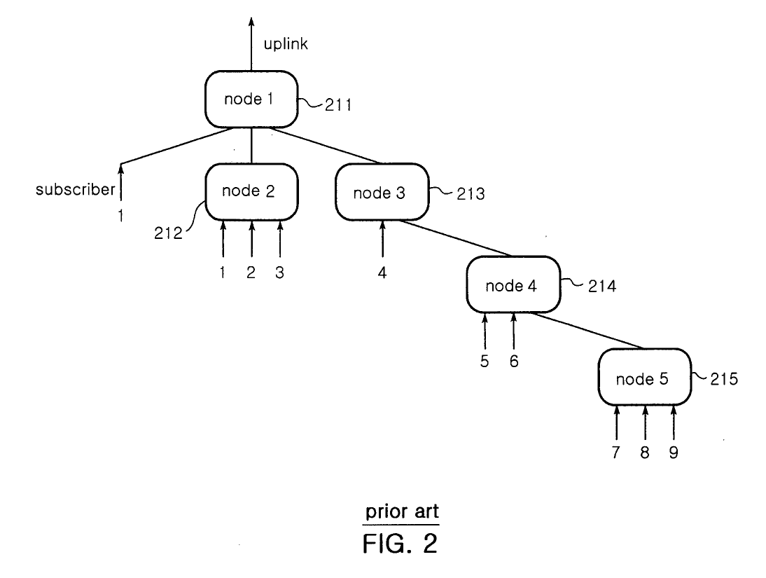

FIG. 3 is a diagram of an Ethernet frame defined in IEEE 802.1Q for illustrating a method of using a virtual LAN (VLAN) tag in the Ethernet frame defined in IEEE 802.1Q as a subscriber identification tag according to a first embodiment of the present invention;

FIG. 4 is a diagram of an Ethernet frame defined in a Q-in-Q scheme for illustrating a method of using an S-VAN tag field as a subscriber identification tag field according to a second embodiment of the present invention;

FIG. 5 is a diagram of a new Ethernet frame for illustrating a method of inserting a subscriber ID tag field at the front of a new Ethernet type field of the new Ethernet frame according to a third embodiment of the present invention;

FIG. 6 is a diagram of a MPLS header for illustrating a method of using a MPLQ label field of the MPLS header as a subscriber identification tag according to a fourth embodiment of the present invention; and

FIG. 7 is a flowchart of a method of processing a packet to provide fairness between subscribers according to an embodiment of the present invention.

### DETAILED DESCRIPTION OF THE INVENTION

Reference will now be made in detail to the preferred embodiments of the present invention, examples of which are illustrated in the accompanying drawings.

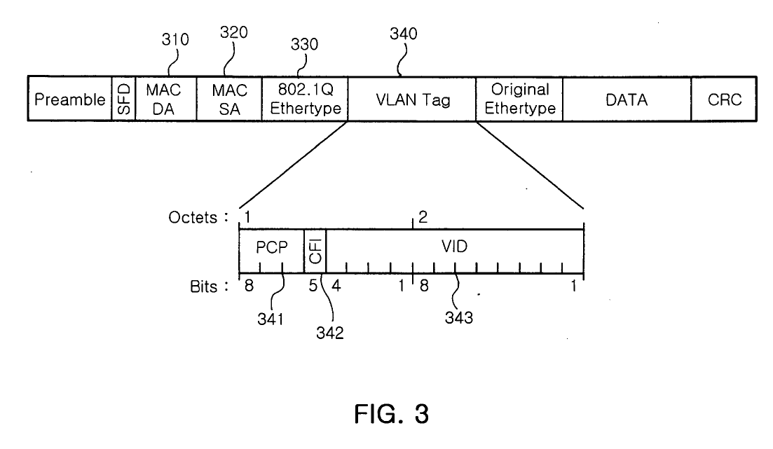

According to the present invention, a subscriber network device directly connected to a subscriber, i.e., an edge node, inserts a subscriber identifying tag denoting the subscriber in a predetermined portion of a packet header when transmitting a packet. The method of inserting the subscriber identification tag may classified into four schemes according to a portion of an Ethernet frame header used as a subscriber identification tag. The four schemes are: 1) a method of using a VLAN field in an Ethernet frame defined in IEEE 802.1Q, 2) a method of using a S-VAN field of an Ethernet frame defined in Q-in-Q which is in progress of standardization as IEEE 802.1ad, 3) a method of defining a new Ethernet frame type value and inserting a subscriber identification tag at the next thereof, and 4) a method of inserting a MPLS label field denoting a subscriber in an Ethernet frame. Hereinafter, the four methods of inserting the subscriber identification tag according to the present invention will be described with reference to FIGS. 3 to 6.

FIG. 3 is a diagram of an Ethernet frame defined in IEEE 802.1Q for illustrating a method of using a virtual LAN (VLAN) tag in the Ethernet frame defined in IEEE 802.1Q as a subscriber identification tag according to a first embodiment of the present invention.

As shown FIG. 3, the Ethernet frame defined in IEEE 802.1Q includes an IEEE 802.1Q Ethertype field 330 for defining a type of Ethernet and a VLAN tag field 340 for a VLAN tag with typical fields of a conventional Ethernet frame. The Ethernet frame of IEEE 802.1Q is used for a virtual local area network (VLAN) between a plurality of end users. That is, it is used for transmitting/receiving Ethernet frames between dedicated users having same VLAN IDs 343. Such a configuration of the Ethernet frame of IEEE 802.1Q allows the dedicated users to share particular information. That is, the Ethernet frame of IEEE 802.1Q is defined to prevent broadcasting information to be transferred to unauthorized persons for solving security problems. In the first embodiment of the present invention, the VLAN tag field 340 of the Ethernet frame of IEEE 802.1Q is used for other purpose. That is, the VLAN tag field 340 is used as a field to identify a subscriber by inserting a subscriber identification tag into the VLAN tag field 340.

The VLAN tag field 340 includes a VLAN ID field 343 of 12 bit recording a VLAN ID as shown in FIG. 3. According to the first embodiment, the subscriber identification (ID) is recorded at the VLAN ID field 343 and the VLAN tag is used as a subscriber ID tag. The subscriber ID is a unique sequence of bits assigned to each of subscribers. Such unique subscriber IDs are previously allocated to all of subscriber ports, or a new subscriber ID is allocated to a subscriber device through an authentication process when the service is provided. As another embodiment of the method of inserting the subscriber ID tag according to the first embodiment, the subscriber ID is recorded in the entire VLAN tag field 340 of 16 bit and the VLAN tag is used as the subscriber identification tag. Furthermore, the VLAN tag field 340 includes a priority field 341 of 3 bit. A priority of packet may be recorded in the priority field 341 after analyzing previously transmitted packets. Since the analysis of priority is performed only in a first node, processing load of packet may be reduced.

However, the VLAN tag field 340 cannot be used as an original purpose of the VLAN after inserting the subscriber ID tag according to the first embodiment of the present invention. That is, it is impossible to provide a virtual private network to subscribers if the VLAN tag field 340 is used according to the first embodiment. Accordingly, the VLAN tag field 340 may be unrecognized and a subscriber network device may malfunction when the subscriber network is configured of different types of networks. For example, if the Ethernet frame having the subscriber ID tag instead of the VLAN tag 340 is transmitted to a device of the VLAN, the device of the VLAN may wrongly analyze the subscriber ID tag. If the Ethernet frame having the VLAN tag 340 is transmitted to a subscriber device of the present invention, it causes malfunctioning of the subscriber device. Therefore, it may use a method of defining a new Ethernet type value to distinguish the subscriber ID from the VLAN tag when the subscriber network includes different type of sub-networks.

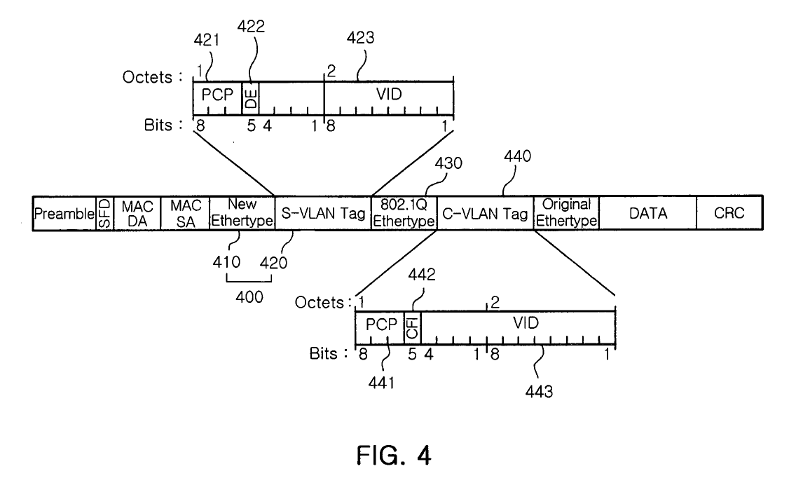

FIG. 4 is a diagram of an Ethernet frame defined in a Q-in-Q scheme for illustrating a method of using an S-VAN tag field as a subscriber identification tag field according to a second embodiment of the present invention.

As shown in FIG. 4, the Ethernet frame includes a supplementary VLAN tag field 420, called as S-VLAN tag field, at the front of a conventional VLAN tag field of the Ethernet frame of IEEE 802.1Q, called as a C-VLAN tag field with other conventional fields of the Ethernet frame of IEEE 802.1Q. The conventional VLAN tag field was not enough to expresses a new type of Ethernet when the conventional Ethernet expands to a metro Ethernet. The S-VAN tag field 420 is added in the conventional Ethernet frame of IEEE 802.1Q to define a new Ethernet type and supplement VLAN portion. Such a technology is known as the Q-in-Q and is in progress for standardizing as IEEE 802.1ad. In the second embodiment of the present invention, the S-VLAN tag field 420 is used to identify a subscriber in a subscriber network as shown in FIG. 4.

An Ethernet frame transmitted from a subscriber device does not include the S-VLAN tag field because it is used for a metro Ethernet region. Therefore, a subscriber network device directly connected to a subscriber inserts an S-VLAN field 400 having a new Ethernet type value field 410 and an S-VLAN tag field 420 into the Ethernet frame. The inserted S-VLAN tag field of the S-VLAN field 400 includes a VLAN ID field 423 for recording a VLAN ID of 12 bit. In the second embodiment of the present invention, a subscriber ID is recorded in the VLAN ID field 423 to identify a subscriber and the VLAN tag is used as the subscriber ID tag. The subscriber ID is a predefined bit sequence, and it is assigned through 1) previously allocating the subscriber IDs to all of subscriber ports and 2) allocating a new subscriber ID to each of subscriber devices in an authentication process when the service is providing. As another embodiment of the method of inserting the subscriber ID tag according to the second embodiment, the subscriber ID may be recorded in the entire S-VLAN tag field 420 of 16 bit and the S-VLAN tag is used as the subscriber ID field. In more specific, if 12 bits of the S-VLAN tag field 420 is used as the subscriber ID field 423, it allows about 4096 subscribers to receive the subscriber ID. If it is expected that more subscribers than 4096 participating in the subscriber network, the subscriber ID field 423 must be expanded. In this case, the entire S-VLAN field of 16 bit including a priority field 412, a DE field 422 and the VLAN ID field 423 may be used as the subscriber ID field. If the entire S-VLAN tag field is used as the subscriber ID field, the priority field 423 cannot be used as its own purpose. In this case, a priority field 441 for a conventional VLAN can be used as the priority field 421 for the S-VLAN without any trouble because the priority field 441 contains overlapped information defined in the S-VLAN and the C-VLAN. Therefore, the subscriber IDs can be assigned to about 65,536 subscribers if the entire S-VLAN field is used as the subscriber ID field.

Furthermore, as still another embodiment of the method of inserting the subscriber ID tag according to the second embodiment, the subscriber ID is recorded in the VLAN ID field 443 in the C-VLAN tag 440 and the C-VLAN tag 440 is used as the subscriber ID tag. Moreover, the subscriber Id is recorded in the entire C-VLAN tag field 440 and the entire C-VLAN tag field 440 is used as the subscriber ID tag field as a further still another embodiment of the method of inserting the subscriber ID tag according to the second embodiment. The use of the C-VLAN tag field 440 as the subscriber ID field may be achieved by same method of using the S-VLAN tag field 420 as the subscriber ID field.

The method of using the S-VLAN tag field 420 as the subscriber ID field according to the second embodiment of the present invention can be used in the subscriber network without any collisions arisen between the conventional VLAN and the S-VLAN because functions of the conventional VLAN are supported through the C-VLAN tag and the use of the S-VLAN is defined within the metro Ethernet network.

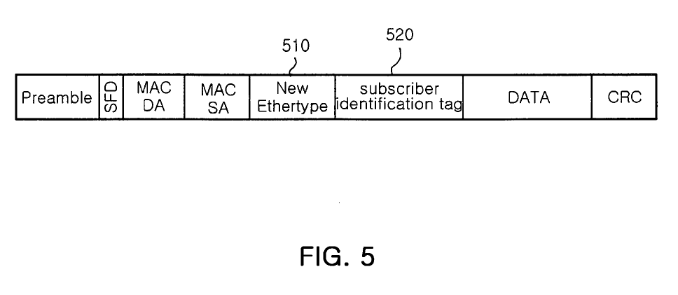

FIG. 5 is a diagram of a new Ethernet frame for illustrating a method of inserting a subscriber ID tag field at the front of a new Ethernet type field of the new Ethernet frame according to a third embodiment of the present invention.

As shown in FIG. 5, a New Ethertype field 510 for new Ethernet type value is defined without using the conventional VLAN tag field and a subscriber ID tag field 520 is inserted at the front of the new Ethernet type value field 510. The subscriber Id is recorded in the subscriber ID tag field 520. It may be a weak point of the method according to the third embodiment since it uses an undefined format of Ethernet frame according to the standards. In order to classify the packets by the subscriber, it requires a new type of devices for a subscriber network. Therefore, it may be an advantageous feature of the method according to the third embodiment that new subscriber ID tag types can be defined according to target purposes. For example, a field for the subscriber ID can be expanded to accommodate more number of subscribers, for example, more than 65,536 subscribers. Also, the new Ethernet type value field can be expanded to record a priority of corresponding packet, any expanded value or other necessary factors.

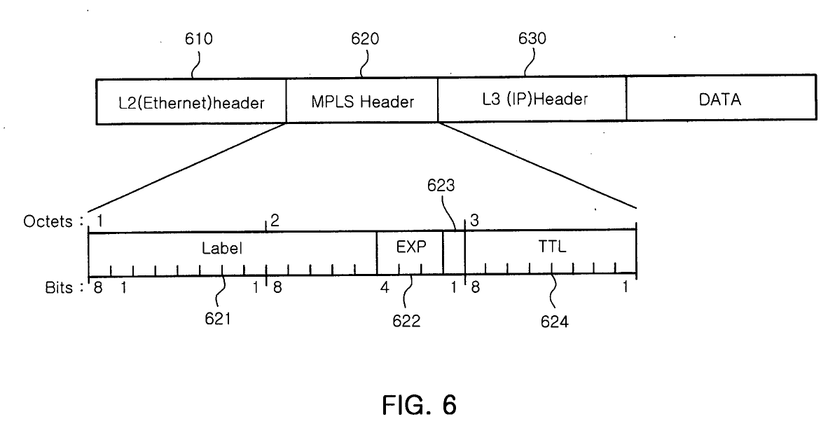

FIG. 6 is a diagram of a MPLS header for illustrating a method of using a MPLS label field of the MPLS header as a subscriber identification tag according to a fourth embodiment of the present invention.

As shown in FIG. 6, the MPLS header 620 is located between an Ethernet header 610, which is a second layer (L2) and an IP header 630 which is a third layer (L3). The multi-protocol label switching (MPLS) technology processes a routing operation of the third layer as a switching operation of the second layer based on the previously allocated MPLS label according to a path. Accordingly, the process speed is accelerated and resources are previously reserved according to the path. In the method of inserting the subscriber ID according to the fourth embodiment, the MPLS label field 621 is used as the subscriber ID field to record the subscriber ID. In more specific, the MPLS header is rarely included in the Ethernet frame transmitted from the subscriber device for the Ethernet network. Therefore, the subscriber network device directly connected to the subscriber inserts the MPLS header field 620 including the MPLS label field 621 of 20 bit, an EXP field 622 of 3 bit, an S field 623 of 1 bit and a TTL field 624 of 8 bit. The subscriber ID is recorded in the MPLS label field 621 in the MPLS header 620 and the MPLS label field 621 is used as the subscriber ID field.

Since the MPLS header 620 does not have any purpose in the subscriber network, there is no collision occurred in the subscriber network although the MPLS header 620 is used for other purpose. Since the L2 header field 610 and the L3 header field 630 are not directly included, it is very easy to delete and insert. Furthermore, the subscriber IDs can be assigned to about 1,048,576 subscribers though using the MPLS label 621 as the subscriber ID field because the MPLS label 621 is configured of 20 bits. That is, sufficient scalability is provided according to the fourth embodiment of the present invention.

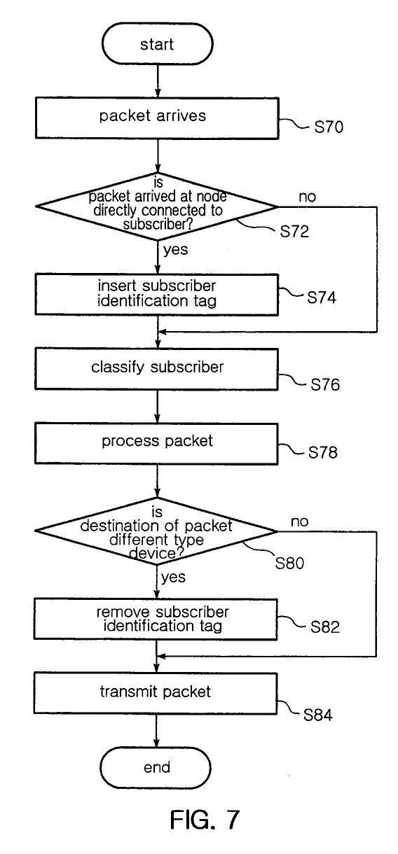

FIG. 7 is a flowchart of a method of processing a packet to provide fairness between subscribers according to an embodiment of the present invention. The method shown in FIG. 7 can be applied not only to a subscriber device directly connected to a subscriber, i.e., an edge node, but also to a subscriber not directly connected to the subscriber, i.e., an intermediate node. It is because a single subscriber device can be used as the edge node or the intermediate node.

Referring to FIG. 7, if an Ethernet device receives a packet at step S70, the Ethernet device determines whether the received packet is a packet received at a port directly connected to a subscriber at step S72. That is, it determines whether the packet is directed received from the subscriber in the Ethernet network. If the received packet is the packet received at the port directly connected to the subscriber at the step S72, a subscriber ID tag with a subscriber ID inserted in a predetermined portion of the packet for identifying the subscriber at step S74. Then, the subscriber ID is read from the subscriber ID tag and the packet is classified according to the subscriber at step S76. Herein, the methods of inserting the subscriber ID according to the first, the second, the third and the fourth embodiments shown in FIGS. 3 to 6 are used for inserting the subscriber ID into the packet in the step S74. If the received packet is not a packet received at a port directly connected to a subscriber at the step S72, it is a packet received at an intermediate node which is not directly connected to the subscriber. Accordingly, the received packet must include the subscriber ID inserted by a previous node. Therefore, the intermediate node reads the subscriber ID from the subscriber ID tag in the received packet and classifies the received packet by the subscriber at step S76. The classified packets are process according to the subscriber at step S78 and the service is provided to the subscriber with fair quality of service (QoS). In processing the packets at the step S78, a bandwidth per each subscriber may be limited for the classified packets by a subscriber. That is, the bandwidth of each subscriber is controlled to fairly assign a bandwidth to subscribers.

Also, a queuing process may be performed for storing the classified packets at the step S78. Furthermore, a scheduling process may be performed for deciding an order of outputting the classified packets at the step S78. Such a bandwidth limiting process, a queuing processes and a scheduling process are required to guarantee the fairness to subscribers.

Before transmitting the processed packet, it determines a destination of the processed packets at step S80. That is, it determines whether the destination of the processed packets is different type of network devices or subscriber devices which cannot recognize the subscriber ID tag inserted according to the present invention. The subscriber ID tag may cause malfunctioning of the different type network devices or subscriber devices. Therefore, if the destination of the processed packet is the different type devices at step S80, the subscriber ID tag is removed from the processed packet at step S82 and the processed packets are transmitted to the destination at step S84. If not, the processed packets are transmitted without removing the subscriber ID tag at step S84. As described above, the subscriber ID tag field is removed at step S82 if the packet is transmitted to the different type of the network device according to the present invention.

As describer above, the intermediate node which is not directly connected to a subscriber receives an Ethernet packet having a subscriber ID tag which is inserted by a predetermined node, i.e., an edge node or other intermediate node. Therefore, the intermediate node reads the subscriber ID from the subscriber ID tag, classifies the packets by the subscriber and processed based on the classified result. As a result, the QoS is fairly provided to subscribers.

In classifying packets by the subscriber at the steps S76 and S78, the received packets may be classified by a priority or a flow for precisely providing a quality of service (QoS) to subscribers.

As described above, the traffics can be classified by a subscriber even at the intermediate node that is not directly connected to the subscriber and the classified traffic can be processed in a unit of the subscriber although the subscriber network is expended to have a typical topology. Therefore, the traffic processes are not discriminated according to a location where the subscriber is connected to the subscriber network. That is, fairness of subscribers is guaranteed according to the present invention. Since the priority of the packet is decided at the edge node which is directly connected to the subscriber in the method of inserting the subscriber ID tag according to the second embodiment, less processing power is required to provide the fairness to the subscribers. Therefore, the subscriber network is simply managed and effectively expanded while providing the fairness to the subscriber with less loads according to the method of providing the fairness to the subscribers according to the present invention.

As described above, a node at a higher layer, which is not directly connected to the subscriber, can classify the packets by a subscriber through inserting the subscriber ID tag into a predetermined portion of the packet header according to the present invention. Therefore, the fair line concentration is provided according to a subscriber according to the present invention.

Furthermore, the bandwidth can be fairly distributed to the subscribers without regarding to a location of a port connecting the subscriber to the subscriber network although the subscriber network is expanded to a typical topology because the packets are classified by each subscriber according to the present invention.

Moreover, the intermediate node, which is not directly connected to the subscriber, can classify the packets by each subscriber with less cost by inserting the subscriber ID tag into the predetermined portion of the packet header and using it as the subscriber ID tag according to the present invention. Therefore, the packets are fairly processed based on the classifying result in correspondence to each of the subscribers, and the QoS is guaranteed corresponding to a service cost charged to each of the subscribers.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of processing a packet using a subscriber identification tag in an Ethernet network, the method comprising steps of:
receiving an Ethernet frame from a subscriber at an edge node directly connected to the subscriber in the Ethernet network and forming a subscriber identification tag by inserting a subscriber ID (identification) for identifying the subscriber in a predetermined portion of an Ethernet frame header in the received Ethernet frame;
classifying an Ethernet frame according to its subscriber by reading a subscriber identification tag included in an Ethernet frame header in the Ethernet frame at an intermediate node in the Ethernet network; and
processing the classified Ethernet frame according to each of subscribers.

2. The method of claim 1, wherein in the step of forming the subscriber identification tag, the subscriber ID is recorded in a field for recording VLAN (virtual local area network) ID in a VLAN tag of an Ethernet frame defined in IEEE 802.1Q and the VLAN tag is used as the subscriber identification tag.

3. The method of claim 1, wherein in the step of forming the subscriber identification tag, the subscriber ID is recorded in a field for recording a VLAN tag in an Ethernet frame defined in IEEE 802.1Q and the VLAN tag is used as the subscriber identification tag.

4. The method of claim 1, wherein in the step of forming the subscriber identification tag, the subscriber ID is recorded in a field for recording a S-VLAN ID in a S-VLAN tag of an Ethernet frame defined in a Q-in-Q scheme and the S-VLAN tag is used as the subscriber identification tag.

5. The method of claim 1, wherein in the step of forming the subscriber identification tag, the subscriber ID is recorded in a field for recording a S-VLAN tag in an Ethernet frame defined in a Q-in-Q scheme and the S-VLAN tag is used as the subscriber identification tag.

6. The method of claim 1, wherein in the step of forming the subscriber identification tag, the subscriber ID is recorded in a field for recording a C-VLAN (conventional-VLAN) ID in a C-VLAN tag of an Ethernet frame defined in a Q-in-Q scheme and the C-VLAN tag is used as the subscriber identification tag.

7. The method of claim 1, wherein in the step of forming the subscriber identification tag, the subscriber ID is recorded in a field for recording a C-VLAN tag in an Ethernet frame defined in a Q-in-Q scheme and the C-VLAN tag is used as the subscriber identification tag.

8. The method of claim 1, wherein in the step of forming the subscriber identification tag, a new Ethernet type value is inserted in a predetermined portion of the received Ethernet frame and the subscriber identification tag having the subscriber ID is formed at the next of the predetermined portion for the new Ethernet type value.

9. The method of claim 8, wherein the subscriber identification tag includes a field representing a priority of a packet to be processed.

10. The method of claim 1, wherein in the step of forming the subscriber identification tag, a MPLS (multi-protocol label switching) header is inserted into the received Ethernet frame, the subscriber ID is recorded in a field of recording a MPLS label in the MPLS header and the MPLS header is used as the subscriber identification tag.

11. The method of claim 1, wherein in the step of classifying, the Ethernet frames are classified according to the subscriber ID in the subscriber identification tag and a priority.

12. The method of claim 11, wherein in the step of classifying, the priority is recorded in the subscriber identification tag.

13. The method of claim 1, wherein in the step of classifying, the Ethernet frames are classified by the subscriber ID of the subscriber identification tag and a flow.

14. The method of claim 1, wherein in the step of processing, the classified Ethernet frames are processed to guarantee fairness to the subscriber.

15. The method of claim 1, wherein the step of processing includes the steps of:
determining whether a destination of the Ethernet frame is a different Ethernet device or subscriber device which is directly connected from the edge node; and
removing the subscriber identification tag from the Ethernet frame if the destination of the Ethernet frame is the different Ethernet device or subscriber device which is directly connected from the edge node.

16. The method of claim 1, wherein the step of processing includes the step of limiting a bandwidth of each subscriber based on the classified Ethernet frames according to the subscriber.

17. The method of claim 1, wherein the step of processing includes the step of storing the classified Ethernet frames according to an order of classifying.

18. The method of claim 1, wherein the step of processing includes the step of deciding an order for outputting the classified Ethernet frame as an order of classifying.
